(19) United States
(12) Patent Application Publication
(10) Pub. No.: US 2003/0103086 A1
(43) Pub. Date: Jun. 5, 2003

(54) Method for viewing geolocated images linked to a context

(75) Inventors: Guy Robinson, Aylesbury (GB); Olivier Alain Furon, Paris (FR)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/306,037

(22) Filed: Nov. 27, 2002

(30) Foreign Application Priority Data
Nov. 30, 2001 (FR) 0115475

(51) Int. Cl. G09G 5/00

(52) U.S. Cl. 345/810

(57) ABSTRACT

The present invention is in the technical field of digital imaging. The present invention relates to a method that enables a user, having a portable terminal comprising a display screen, to display still or moving digital images; with the images being linked to a time context selected by the user. A characteristic of the invention is to enable the supply of images that are a function of the user's preferred context in relation to each of the images. The content of the images takes into account the contextual parameters selected by the user. This is done so as to display contextual digital data of an image of a geographic location on the portable terminal having a display screen. The application of the invention relates to the users of portable terminals comprising display screens.

### CONTEXT

This is a U.S. original application which claims priority on French patent application No. 0115475 filed Nov. 30, 2001.

### FIELD OF THE INVENTION

The present invention is in the technical field of digital imaging. The present invention relates to a method for viewing the images of a geographic location on a portable terminal, the images each representing a specific context selected by a user.

### BACKGROUND OF THE INVENTION

Tele-messaging services enable the reception, on request, of information on portable terminals or personal digital assistants (PDA); these interactive services are widely disclosed and exploited. The objective of these services is to supply information in real time to a user having a personal assistant. For example, this information relates to geolocation data (interactive city maps), meteorological data, etc. This data is revised or updated periodically. One example of a method and system automatically supplying these types of services is described in U.S. Pat. No. 6,202,023. U.S. Pat. No. 6,202,023 describes a method and a system for, in a mobile environment (wireless network), for example by using the internet, automatically supplying to the users of portable terminals, geolocated information that is revised and specific to a given zone or geographic location. For example, a user formulates a request from the portable terminal—the request is based on the interrogations, choices or preferences of the user, related to their needs. These needs can be, for example, knowing if a hotel located in a place near the user is full or not, or knowing what the weather conditions are in a given location where the user is heading, etc. The system analyzes the user's needs and reproduces, on the display screen of the portable terminal, texts and/or graphics (e.g. geographic maps) corresponding to the request data.

### SUMMARY OF THE INVENTION

The present invention relates to a method that enables a user, having a portable terminal comprising a display screen, to display still or moving digital images; the displayed images being linked to a time context selected by the user. These images come, for example, from photographs of a geographic location, and they are linked to a context of the place. A characteristic of the invention is to enable the supply of images of which each is a function of a user's preferred context. The content of the images takes into account the contextual parameters selected by the user, so as to display contextual digital data of these images, for example images of a geographic location, on the display screen of the portable terminal.

The present invention relates more particularly to a method for supplying contextual digital data of an image of a geographic location, on a portable terminal having a display screen, the method comprising the following steps:

a) from the portable terminal, select at least one contextual parameter from among a list of parameters;

b) from the portable terminal, transfer the at least one selected contextual parameter and geolocation information of the geographic location to a server;

c) automatically save, in the server, the at least one contextual parameter and the geolocation information;

d) automatically link, in the server, the at least one contextual parameter and the geolocation information;

e) automatically select at least one image of the geographic location, the image being selected from the combination of data of step d);

f) automatically send to the portable terminal, the at least one selected digital image, corresponding to the combination made in step d); and

g) display on the screen of the portable terminal, the at least one digital image selected in step e).

The characteristics of the invention will appear on reading the following description, with reference to the drawing.

### BRIEF DESCRIPTION OF THE DRAWING

FIG. 1 diagrammatically represents a hardware environment used to implement the method of the present invention.

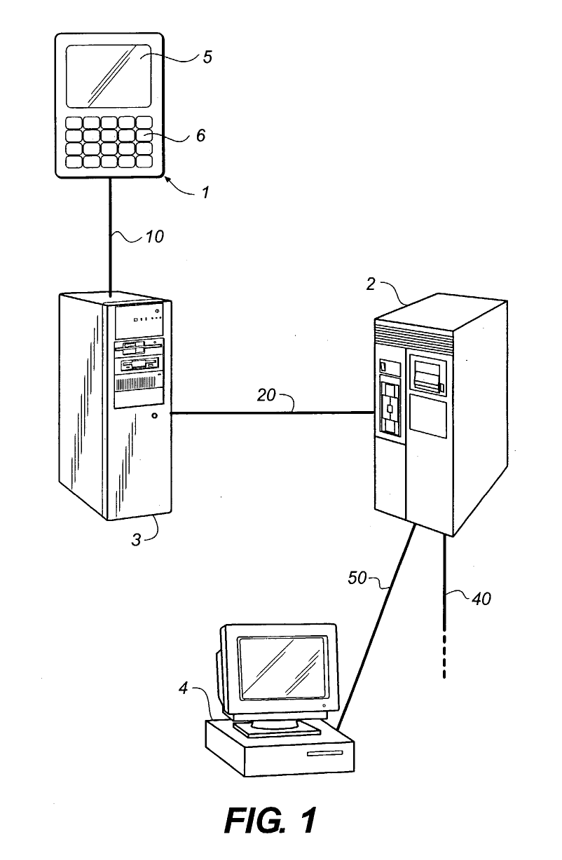

### DETAILED DESCRIPTION OF THE INVENTION

A portable terminal 1 having a display screen 5 is linked to a first server 2, via a gateway 3 of the WAP type (Wireless Application Protocol); this gateway 3 is intended to enable the communication of digital data, through links 10, 20 between the portable terminal 1 and the network, for example GSM (Global System for Mobile) or GPRS (General Packet Radio System). A high-rate link 50 enables the communication of digital data between the first server 2 and a second server 4. The second server 4 contains, for example, indexed digital images in an image database. A link 40 enables the connection with a network such as for example the internet. Information or digital data can thus be recovered from Uniform Resource Locators (URLs) in the internet, which is done, for example, to enhance the image database. The portable terminal 1 is, for example, a digital camera, a cell phone, or a PDA. This portable terminal 1 enables either the recording and viewing of still or moving digital images (short video clips), or only the viewing of the images on the screen 5. The portable terminal 1 is in addition provided with means enabling it to be geolocated. In other words, the portable terminal 1 has, for example, a wireless modem or a GPS type system (Global Positioning System) that enables the provision at any moment and in any location of the geographic position (latitude, longitude) of the portable terminal. This position is given by the geographical coordinates of the location.

The method of the invention is implemented by the user of the portable terminal 1, wishing to display on screen 5 of the portable terminal 1, an image representing a given geographic location, in a particular factual context that the user has selected from the keyboard 6 of their portable terminal. The method of the invention uses image information or digital data and contextual information or digital data. All this information or digital data is processed by an algorithm that enables the execution of the various steps of the method of the invention. The image digital data correspond, for example, to photographs recorded in various geographic locations. The contextual digital data are the parameters linked to a context and selected by the user: in the rest of the description, they are called contextual parameters. The contextual parameters, corresponding to the user's preferences, are linked to an event (time activity) having taken place in a given location. The events are linked, for example, to cultural, sports, tourist activities, etc. The digital images and the contextual parameters are generic or specific. They are called “generic” if their production does not depend on the user; they are called “specific” if their production depends on, or is proper to the user. Examples illustrate these definitions in the later description of the embodiments of the invention. The algorithm used in the method of the invention enables, according to the contextual preferences selected by the user from the portable terminal, the automatic linking of the two types of digital data, i.e. the images and the contextual parameters, to supply the contextual data of an image thus representing, at a given moment, the automatic linking of a given geographic location with a context selected by the user.

One preferred embodiment of the method of the invention includes selecting one or more contextual parameters from the portable terminal 1. These contextual parameters are saved in a database of a server, for example in the first server 2, or in the second server 4. The contextual parameters, from a request made on the keyboard 6 of the terminal 1, can be viewed and selected on the terminal 1. The contextual parameters appear in the form of digital displays mentioning for example geographic locations, a town name, or a famous place in the town; the contextual parameters also mention dates, for example in years (1920, 2000), or seasons (summer, winter); the contextual parameters also mention historic (e.g. a century change), cultural, artistic, sports, tourist events, etc. The above-mentioned contextual parameters are generic. But the user may also want to view an image of a given geographic location, depending on specific contextual parameters, i.e. proper to the user.

The user recovers, for example, an image that they, or even another person, saved previously, in the selected geographic location. In this case, the user selects, from the terminal 1, the name of the person having previously saved the image. This selection is done, for example, from an identification proper to the person. Thus the user selects one or more contextual parameters they wish to link with a geographic location.

The user may, for example, wish to display on the screen 5 of their portable terminal 1, one or more images of the location where they are. These images correspond to a representation of the location in a selected time context, and corresponding to a representation of the location in the past and in a specific context. From the selection by the user of at least one contextual parameter linked to the location where they are, the method of the invention enables, after validation on the keyboard 6, the transfer of the selected contextual parameter(s) and the geolocation information to a first server 2. The geolocation information determines, for example by the latitude and longitude coordinates, the geographic location where the user is. This is done to enable the later reproduction of the contextual digital data of the image on the terminal 1. The geolocation information and the contextual parameter(s) are transferred to the server 2, 4 and saved in the server. If the user is physically at the location where they started the method of the invention, the geolocation information is automatically transferred to the server. The method of the invention then enables the automatic linking of the at least one selected preferred contextual parameter with the geolocation information, then the automatic selection in an image database, of at least one image of the geographic location corresponding to the context selected by the user, and finally the automatic sending and displaying of the image on the screen 5 of the terminal 1.

The user may desire, for example, to view on their portable terminal 1, an image of the location where they are in winter, in the year 1920. They may also wish, if they are for example close to the Eiffel Tower, to want to view an image of the location where they are at the moment of the change of the millennium, etc. The images comprising contextual digital data are saved in an image database. This image database is stored in a server. The image database can be a personal database produced by the user over time, and stored for example in an image server 4. Metadata is linked to each image of the database. Metadata is information linked to each image, information not appearing in the image, but contained and consultable in the header of the digital file of the image. The metadata are, for example, the author of the photo, the time and date of its production, the geolocation coordinates of the image location, etc. These metadata work together with the automatic linking operated by the method of the invention, based on the selected contextual parameters. The image database can also be, for example, a generic database of an internet server, accessible by the link 40. The method of the invention thus enables a vast choice to be obtained for the possible links between the selected contextual parameters and the available images corresponding to the the contextual parameters.

According to a second embodiment of the method of the invention, the user, having their portable terminal 1, may wish to display on the screen 5 of the terminal 1, one or more images of a location where they are not physically present. In this case, the user must know and transmit manually the geolocation information, i.e. the coordinates of the location (latitude, longitude) that they wish to view, by using the keyboard 6. To do this, the user can, for example, retrieve from the server 4, on the screen 5 of the terminal 1, any image of the location they wish to view, and they will recover, for example, the geolocation coordinates included in the metadata of the image.

According to a first alternative of the previous embodiments, the method of the invention enables the automatic saving of the selected image, just after the selection. The user executes a request from the keyboard 6, to display the selected and saved image. The image is saved for example in the first server 2.

A second alternative of the previous embodiments enables the automatic display on the screen 5 of the portable terminal 1 of the selected image(s), immediately after sending it to the terminal 1.

In all the previously described embodiments, several selected images are displayed successively if, during the step of linking the contextual parameter and the geographic location, there are several images in the image database that can be selected in relation to the contextual parameter(s) selected by the user. In this case of displaying several images, the images are preferably displayed automatically and successively, according to display timing. This display timing can be adjusted from the keyboard 6 of the terminal 1. The display timing is, for example, 10 seconds per image. But images can also be displayed manually, from the display of the first image, with the user himself or herself operating the display of each of the following images manually from the keyboard 6.

The invention has been described in detail with particular reference to certain preferred embodiments thereof, but it will be understood that variations and modifications can be effected within the spirit and scope of the invention.

What is claimed is:

1. A method for supplying contextual digital data of an image of a geographic location, on a portable terminal having a display screen, said method comprising the steps of:
a) from the portable terminal, selecting at least one contextual parameter from among a list of parameters;
b) from the portable terminal, transferring the at least one selected contextual parameter and geolocation information of the geographic location to a server;
c) automatically saving, in the server, the at least one contextual parameter and the geolocation information;
d) automatically linking, in the server, the at least one contextual parameter and the geolocation information;
e) automatically selecting at least one image of the geographic location, said image being selected from a combination of data of said step d);
f) automatically sending to the portable terminal, the at least one selected digital image, corresponding to the combination made in said step d); and
g) displaying on the screen of the portable terminal, the at least one digital image selected in said step e).

2. The method of claim 1, wherein the image selected said in step e) is automatically saved in the server immediately after said selection and before sending the image to the portable terminal, said sending being operated based on a request executed from said portable terminal.

3. The method of claim 1, wherein the display on the screen of the portable terminal is automatically operated, immediately after the sending operated in said step f).

4. The method of claim 1, wherein a successive display of several selected images is operated automatically according to adjustable display timing.

5. The method of claim 1, wherein a successive display of several selected images on the screen of the terminal is operated image by image, from a keyboard of said terminal.

6. The method of claim 1, wherein the geolocation information is automatically transmitted to the server.

7. The method of claim 1, wherein the digital image selected in said step f) is automatically displayed on the screen of the terminal.
